(19) United States
(12) Patent Application Publication
(10) Pub. No.: US 2005/0216526 A1
(43) Pub. Date: Sep. 29, 2005

(54) Document management system and document management method

(75) Inventor: Takekazu Kumagai, Kawasaki-shi (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Ohta-ku (JP)

(21) Appl. No.: 11/086,552

(22) Filed: Mar. 22, 2005

(30) Foreign Application Priority Data
Mar. 25, 2004 (JP) 2004-088237

(51) Int. Cl. G06F 7/00

(52) U.S. Cl. 707/201

(57) ABSTRACT

According to a document management system and a document management method, a bookmark is created in document data controlled by a server. When document data are displayed on the screen of a client, a bookmark icon is associated with a page on which a bookmark is created and is displayed on the screen. A list of bookmarks created in the document data is displayed. Rights of a user to access, create, and delete a bookmark are controlled. Whether or not the bookmark is shared with other users can be determined.

### BACKGROUND OF THE INVENTION

1. Field of the Invention

The present invention relates to a document management system and a document management method.

2. Description of the Related Art

Finding desired pages in electronic documents with a great number of pages is not easy, and thus, electronic bookmarks are used to find the desired pages in the electronic documents to maximize efficiency.

According to a technique disclosed in Japanese Patent Laid-Open No. 11-224269, when a bookmark is created on a web page written in hyper text markup language (HTML), the uniform resource locator (URL) of the web page and the positional information within the web page to specify the text information are stored in a bookmark table. When the web page is accessed next time, a list of bookmarks stored in the bookmark table is displayed, and a bookmark of interest is selected in the list to access the web page.

According to a technique disclosed in Japanese Patent Laid-Open No. 2002-007383, when a client retrieves a desired document file from a document file server, the document file is converted into a portable document format (PDF) file in a PDF conversion server and is then transmitted to the client. In this PDF conversion server, when a document file is converted into a PDF file, a bookmark is created in the converted PDF file in accordance with the hierarchical structure of the document file. When a bookmark is created in an electronic document in this manner, a special document format, for example, PDF is defined, and the bookmark information is embedded therein. Therefore, conventionally, electronic bookmarks can only be employed in specific document formats, and thus, document data are required to be converted into the specific format in order to embed the bookmark information.

### SUMMARY OF THE INVENTION

To address the aforementioned problems, the present invention provides a document management system and document management method in which electronic bookmarks can be used regardless of the document format. Furthermore, bookmarks are well controlled in the system and method by introducing a right to access bookmarks.

According to a document management system of an aspect of the present invention, the document management system includes a server for controlling document data using a database in which the document data are stored and a client connected to the server via a network, the server including: a bookmark-creating unit for creating a bookmark at a desired position in the document data in response to a request to create a bookmark from the client; a storing unit for storing bookmark information in a bookmark database; and a transmitting unit for transmitting the bookmark information to the client, the client including: a bookmark-creation-requesting unit for requesting the server to create a bookmark at a desired position in the document data in response to a request from a user of the client and a display unit for displaying the bookmark information transmitted from the server, the bookmark information being associated with the document data on the display.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a schematic view of the structure of a document management system according to a first embodiment of the present invention.

FIG. 2 is a block diagram showing the details of the structure of the document management system shown in FIG. 1.

FIG. 3 is a drawing of a display screen of a document browsing program executed in the document management system of the first embodiment.

FIG. 4 is a drawing of a bookmark list display screen in the document browsing program shown in FIG. 3.

FIG. 5 is a flowchart of a process of creating a bookmark in the document browsing program shown in FIG. 3.

FIG. 6 is a flowchart of a process of deleting a bookmark in the document browsing program shown in FIG. 3.

FIG. 7 is a flowchart of a process of displaying a bookmark list display screen in the document browsing program shown in FIG. 3.

FIGS. 8A-8D are tables illustrating the data structure of the document data used in the document management system according to the first embodiment.

FIG. 9 is a view of a bookmark list display screen in a document management system of a second embodiment according to the present invention.

FIG. 10 is a flowchart of a process of creating a bookmark in the document browsing program executed in the document management system according to the second embodiment.

FIG. 11 is a flowchart of a process of displaying a bookmark list in the document browsing program executed in the document management system according to the second embodiment.

FIG. 12 is a table of the data structure of a bookmark table used in the document management system according to the second embodiment.

FIG. 13 is a view of a bookmark list display screen in the document management system according to a third embodiment of the present invention.

FIG. 14 is a flowchart of creating a bookmark in the document browsing program executed in the document management system according to the third embodiment.

FIG. 15 is a flowchart of a process of displaying a bookmark list in the document browsing program shown in FIG. 13.

FIG. 16 is a flowchart of a process of displaying an initial bookmark list display screen in the document browsing program executed in the document management system according to the third embodiment.

FIG. 17 is a table of the data structure of a bookmark table used in the document management system according to the third embodiment.

FIG. 18 is a block diagram of a document management system according to a fourth embodiment of the present invention.

### DESCRIPTION OF THE EMBODIMENTS

### First Embodiment

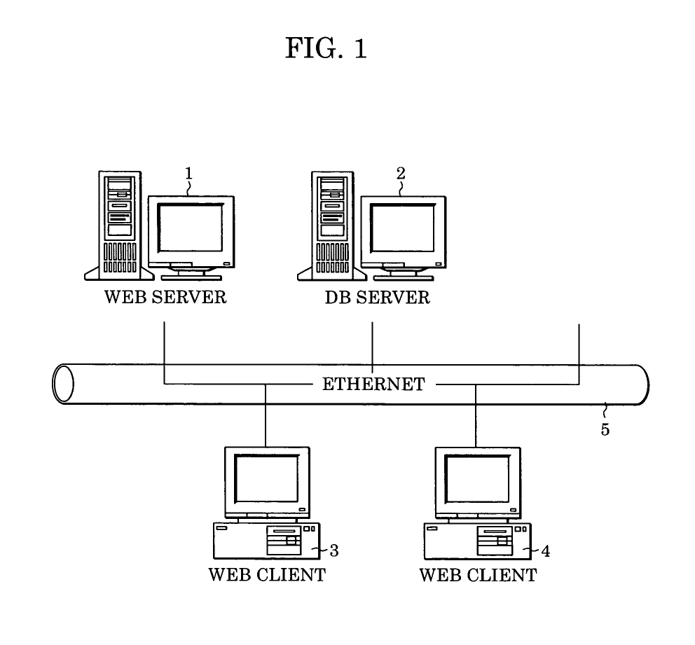

FIG. 1 is a schematic view of the structure of a document management system of a first embodiment according to the present invention.

Referring to FIG. 1, the document management system has a structure similar to that of a normal web application. More specifically, the document management system includes a web server 1, a database (DB) server 2, and web clients 3 and 4, all of which are connected to an Ethernet 5. For simplicity, two web clients 3 and 4 are shown in FIG. 1. The present invention is not so limited and may include one web client or three or more web clients.

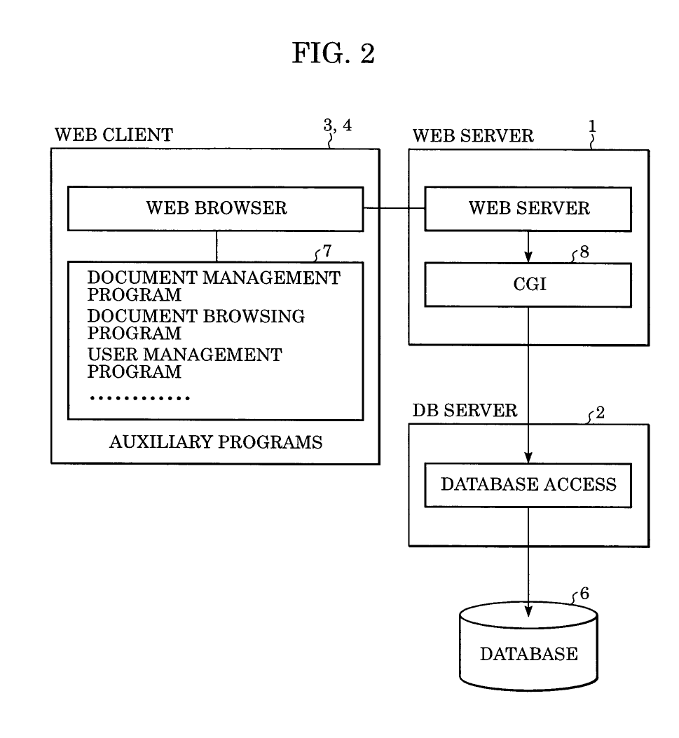

FIG. 2 shows details of the document management system shown in FIG. 1.

Referring to FIG. 2, the web server 1 can communicate with the web clients 3 and 4 bidirectionally by Http/Https protocols via a network. When the web clients 3 and 4 input a command to execute a program, the web server 1 executes the program through a common gateway interface (CGI) CGI 8. At this time, the session information of the web clients 3 and 4 is stored as a file in the web server 1 and controlled therein.

The web server 1 can communicate with the DB server 2 bidirectionally through the Ethernet 5, and a database (DB) 6 is stored in the DB server 2.

When the web clients 3 and 4 request the web server 1 to display data in the DB 6, the web server 1 acquires data from the DB server 2 to display the data on the screen of the web clients 3 and 4.

A web browser can be operated in the web clients 3 and 4, and the web clients 3 and 4 communicate with the web server 1 bidirectionally.

A program operable in the web clients such as a JavaScript program can be executed in the web browser. The web browser includes auxiliary programs, that is, a document management program for controlling documents, a document browsing program for browsing documents, and a user management program for controlling users.

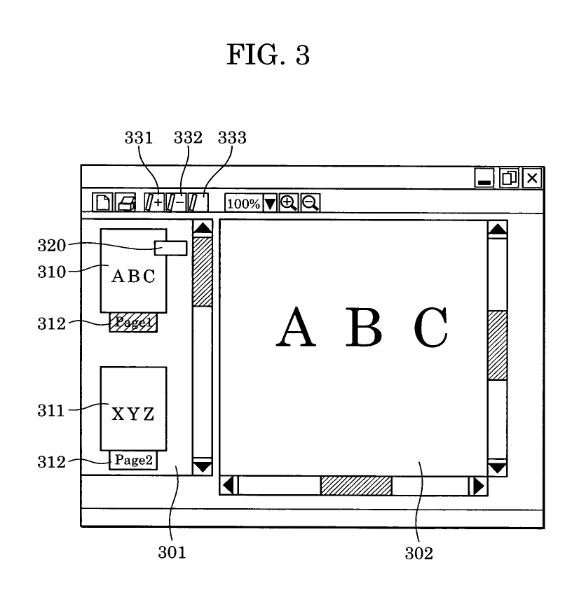

FIG. 3 shows an exemplary display screen of a document browsing program in the web clients 3 and 4. A document controlled by the document management server via the web server 1 is displayed on this display.

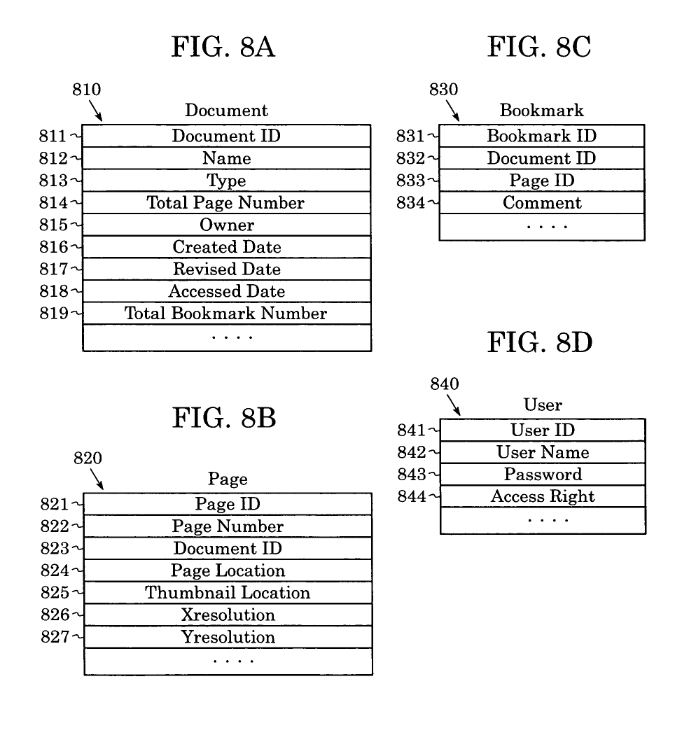

When the display screen shown in FIG. 3 is displayed, a user performs user authentication in the web clients 3 and 4 by inputting a user name and password. In the user authentication, a user table 840 (see FIG. 8D), which will be described below, is used, and the program stores a user ID in a storing region after the user authentication.

In the exemplary screen display shown in FIG. 3, windows 301 and 302 are displayed side-by-side on the screen, and thumbnail images 310 and 311 for individual pages that are in the displayed document are displayed in the left window 301 vertically. The display screens shown in the drawings are exemplary and the information can be displayed in different configurations than shown in the drawings. The thumbnail images 310 and 311 each include a page number 312. The thumbnail images 310 and 311 can be alternatively selected, and the page number 312 of the selected thumbnail image is highlighted. In FIG. 3, the page number 312 for the thumbnail image 310 is highlighted. A bookmark icon 320 is associated with the bookmarked image on the display.

In the right window 302, the page selected in the left window 301 is displayed.

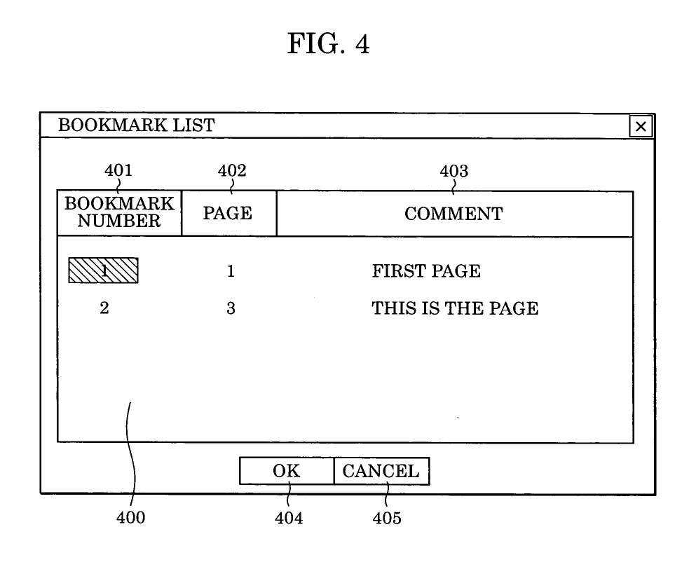

Tool buttons 331, 332, and 333 are disposed on the upper part of the screen. The tool button 331 is used to create a bookmark. The tool button 332 is used to delete a bookmark. The tool button 333 is used to display a bookmark list (see FIG. 4).

Referring to FIG. 4, the bookmark list display screen displays a list box 400 in the center and an OK button 404 and a cancel button 405 in the bottom of the screen. The list box 400 includes columns for a bookmark number 401, a page number 402, and a comment 403 for bookmarked pages.

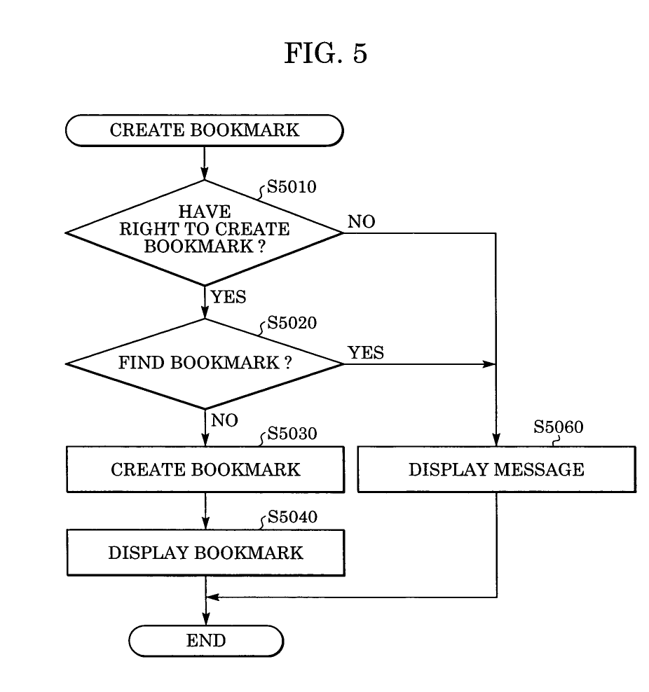

When the tool button 331 is depressed on the screen shown in FIG. 3, a bookmark is created by performing steps shown in a flowchart in FIG. 5 and described next.

Step S5010: When the web client 3 or 4 requests to create a bookmark on a selected page, the web server 1 makes a query to the DB 6 so as to access a user table 840 with a user ID and confirms whether or not the web client 3 or 4 has an access right. When the web server 1 confirms that the requesting web client 3 or 4 has the access right, the process proceeds to Step S5020. When the web server 1 does not confirm that the requesting web client 3 or 4 has the access right, the process proceeds to Step S5060. In Step S5060, a message indicating that a bookmark cannot be created is displayed and the process is terminated.

Step S5020: Whether or not the page on which a bookmark is to be created has not already been bookmarked is checked using a document table 810 and a bookmark table 830 in the DB 6 (see FIGS. 8A-8C). When the page has not been bookmarked, the process proceeds to Step S5030. When the page has been bookmarked, the process proceeds to Step S5060. In Step S5060, a massage indicating that the page has been already bookmarked is displayed and the process is terminated.

Step S5030: A request to create a new bookmark is made of the web server 1. In accordance with the request, the web server 1 creates a record of the new bookmark in the bookmark table 830 and totals the number of bookmarks in the document table 810.

Step S5040: The created bookmark is displayed on the screen of the document browsing program, and the process is terminated. In the present embodiment, a created bookmark 320 is associated with the thumbnail image 310 on the display screen, for example.

Step S5060: As described above, a message indicating that the requesting web client 3 or 4 does not have a right to create a bookmark or that the page has already been bookmarked is displayed on the screen of the requesting web client 3 or 4, and the process is terminated.

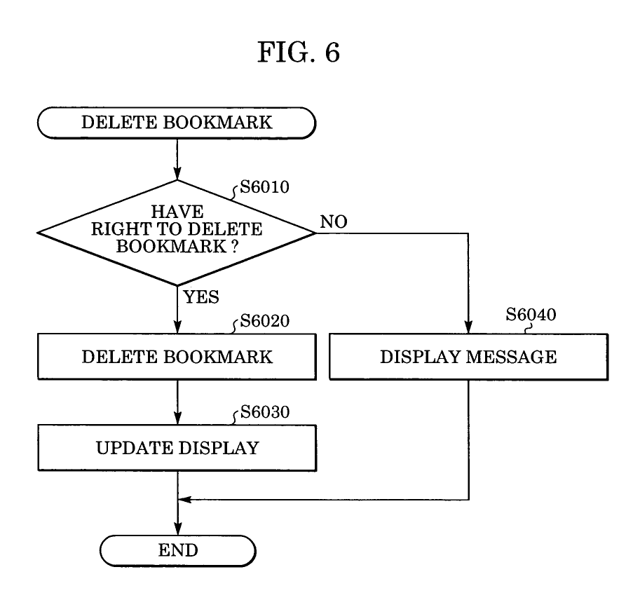

When the tool button 332 is depressed on the screen shown in FIG. 3, a bookmark is deleted by performing steps shown in the flowchart in FIG. 6.

Step S6010: When the web client 3 or 4 requests to delete a bookmark from a selected page, the web server 1 makes a query to the DB 6 so as to access the user table 840 with the user ID and confirms whether or not the requesting web client 3 or 4 has an access right. When the web server 1 confirms that the requesting web client 3 or 4 has a right to delete a bookmark, the process proceeds to Step S6020. When the web server 1 does not confirm that the requesting web client 3 or 4 has a right to delete a bookmark, the process proceeds to Step S6040. In Step S6040, a message indicating that the bookmark cannot be deleted is displayed and the process is terminated.

Step S6020: A request is made of the web server 1 to delete the selected page. In accordance with the request, the web server 1 deletes the record of the selected bookmark and totals the number of bookmarks in the document table 810.

Step S6030: The deleted bookmark is removed from the screen of the document browsing program, and the process is terminated.

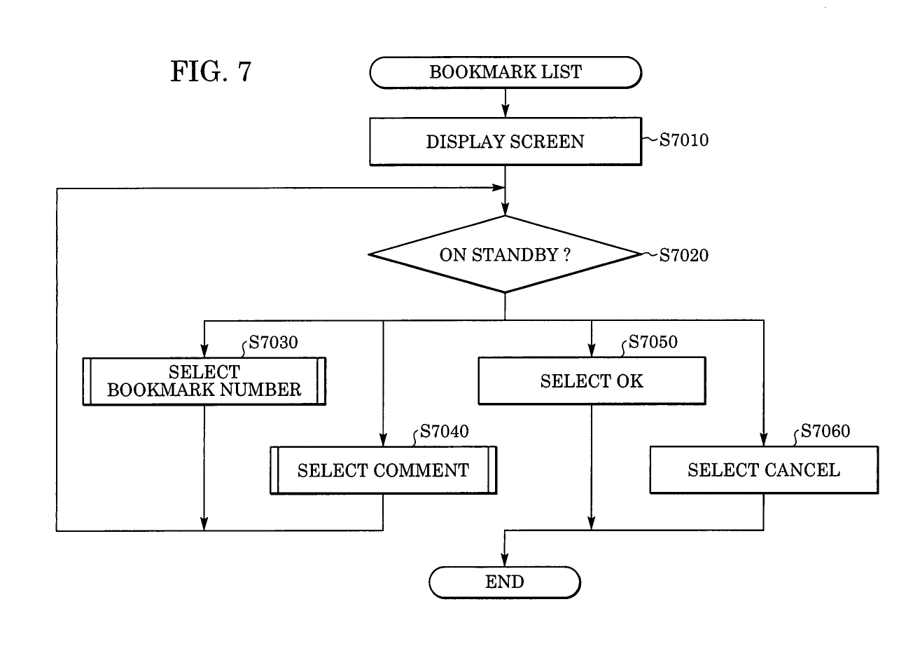

When the tool button 333 is depressed on the screen shown in FIG. 3, the bookmark list display screen shown in FIG. 4 is displayed by performing the steps shown in the flowchart in FIG. 7.

Step S7010: First, an initial screen is displayed. The bookmark number 401, the page number 402, and the comment 403 are listed on the initial display screen shown in FIG. 4 by accessing the page table 820 and the bookmark table 830. Since a process for the initial screen display in the first embodiment is quite simple, the process is not described here.

Step S7020: The process is on standby until a request is input. In accordance with the input request, the process proceeds to different steps. Specifically, when the bookmark number 401 is selected, the process proceeds to Step S7030. When the comment 403 is selected, the process proceeds to Step S7040. When the OK button 404 is selected, the process proceeds to Step S7050. When the cancel button 405 is selected, the process proceeds to Step S7060.

Step S7030: The selected bookmark number is highlighted, and the process returns to Step S7020.

Step S7040: A comment is selected and the selected comment is made editable. When the comment is revised, a request to revise the comment is sent to the web server 1, and the web server 1 revises the comment in the bookmark table 830. Then, the process returns to Step S7020.

Step S7050: The bookmark selected on the bookmark list display screen in Step 7030 is identified. The page on which the selected bookmark is created is displayed on the screen of the document browsing program, and the process for displaying a bookmark list display screen is terminated.

Step S7060: No process is performed on the bookmark list display screen, and the process for displaying a bookmark list is terminated. Then, the screen returns to the document browsing screen shown in FIG. 3.

Referring to FIGS. 8A to 8D, the document table 810, the page table 820, the bookmark table 830, and the user table 840 stored in the DB 6 have data structures described below.

The document table 810 (FIG. 8A) has records regarding document data. Each record includes the following fields: a document ID 811 for specifying document data, a name 812 of the document data, a type 813 of the document data, a total page number 814 of the document data, an owner 815 of the document data, a created date 816 for indicating the date and time when the document data is created, a revised date 817 indicating the date when the document data is revised, an accessed data 818 indicating when the document was accessed last, a total bookmark number 819 of the created bookmarks, and the like.

When a document is created, a record of the document is created, and when the document is deleted, the corresponding record is deleted. When the web clients input commands in the document management program, the values in the fields are accessed or revised.

The page table 820 stores records regarding pages of the document data. Each record includes the following fields: a page ID 821 for specifying a page, a page number 822 for indicating the page number in the document data, a document ID 823 for the document data including the page, a page location 824 for indicating where the page is actually stored, a thumbnail location 825 for indicating where the data of a thumbnail for the page are stored, an X-resolution 826 for indicating resolution of the page in the horizontal direction, a Y-resolution 827 for indicating resolution of the page in the longitudinal direction and the like.

When a page is created, a record for the page is created. When the document is deleted, the corresponding page record(s) is/are deleted. When the web clients input commands in the document management program, the values in the fields are accessed or revised.

The bookmark table 830 stores records regarding bookmarks. Each record includes the following fields: a bookmark ID 831 of a bookmark, a document ID 832 of the document data in which the bookmark is created, a page ID 833 for specifying the page on which the bookmark is created, a comment 834 for the bookmark and the like.

When a bookmark is created, a record for the bookmark is created, and when the document is deleted, the corresponding bookmark record(s) is/are deleted. When the web clients input commands regarding the bookmark in the document management program, the values of the fields are accessed or revised.

The user table 840 stores records regarding users. Each record includes the following fields: a user ID 841 of a user, a user name 842 of the user, a password 843 of the user, an access right 844 of the user, and the like. In the access right 844, a right to create a bookmark, a right to delete a bookmark and the like can be individually set.

When a user is created by the user management program, a record for the user is created. When the user is deleted, the corresponding record is deleted. When the web clients input commands regarding user information in the user management program, document management program, and document browsing program, the values in the fields are accessed or revised.

As described above, according to the first embodiment, since bookmarks are controlled in the DB 6 that is different from the database for the document data, bookmarks are created regardless of the type of the document data.

Furthermore, since the document management system according to the first embodiment employs the access right to revise or access the information of bookmarks, a more sophisticated method for browsing a document can be provided.

### Second Embodiment

A document management system of the second embodiment according to the present invention will now be described by referring to the drawings.

The document management system of the second embodiment has the same structure as that of the document management system of the first embodiment, shown in FIGS. 1 and 2. Also, operations to create and delete bookmarks, to display a bookmark list, and the like can be performed by, for example, the document browsing program shown in FIG. 3.

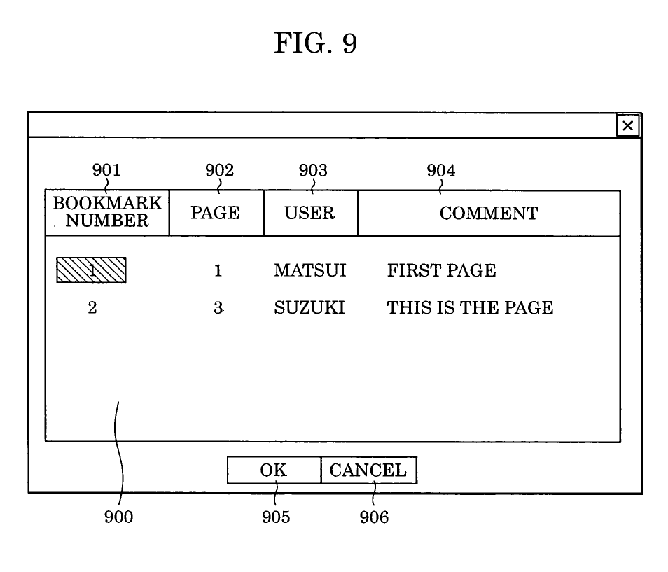

In the second embodiment, a separate bookmark can be set for each user. When the tool button 333 is depressed on the screen of the document browsing program shown in FIG. 3, a bookmark list display screen such as the one shown in FIG. 9 is displayed.

In FIG. 9, the exemplary bookmark list display screen has a list box 900 in the center and an OK button 905 and a cancel button 906 in the bottom of the screen. The list box 900 includes columns for a bookmark number 901 and a page number 902 of the page on which the bookmark is created, a user name 903 of the user created the bookmark, and a comment 904.

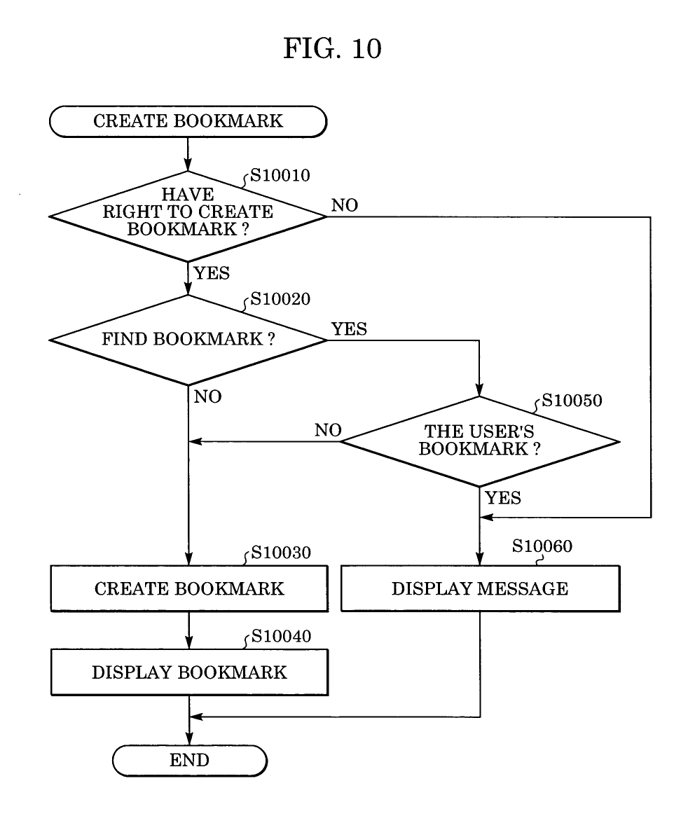

When the tool button 331 is depressed on the screen shown in FIG. 3, a bookmark is created by performing steps shown in the flowchart in FIG. 10.

Step S10010: When a web client 3 or 4 requests to create a bookmark on a selected page, the web server 1 makes an inquiry to the DB 6 by accessing the user table 840 with the user ID to confirm whether or not the requesting web client 3 or 4 has an access right. When the web server 1 confirms that the web client 3 or 4 has the access right, the process proceeds to Step S10020. When the web server 1 does not confirm that the requesting web client 3 or 4 has the access right, the process proceeds to Step S10060. In Step S10060, a message indicating that a bookmark cannot be created is displayed and the process is terminated.

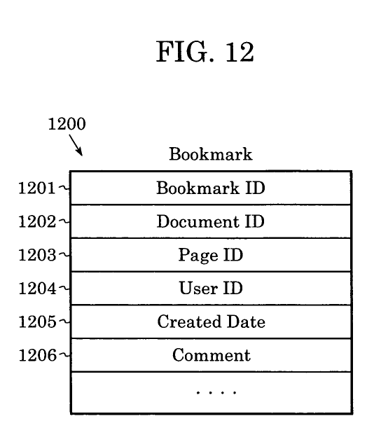

Step S10020: Whether or not the page on which a bookmark is to be created has at least one bookmark is checked using the document table 810 and a bookmark table 1200 (see FIG. 12). When the page has not been bookmarked, the process proceeds to Step S10030. When the page has been bookmarked, the process proceeds to Step S10050.

Step S10030: A request to create a new bookmark is made of the web server 1. In accordance with the request, the web server 1 creates a new bookmark in the bookmark table 1200 and totals the number of bookmarks in the document table 810.

Step S10040: The created bookmark is displayed on the screen of the document browsing program and the process is terminated.

Step S10050: Whether or not the bookmark found in Step S10020 was created by the present user is determined. When the bookmark was created by the present user, the process proceeds to Step S10060 to notify the user that the page has been bookmarked. When the bookmark was not created by the present user, the process proceeds to Step S10030 to create a bookmark for the requesting user as described above.

Step S10060: A message indicating that the user does not have a right to create a bookmark, or that the page has already been bookmarked by the user is displayed, and the process is terminated.

When the tool button 332 is depressed on the screen shown in FIG. 3, a bookmark is deleted by performing the steps shown in the flowchart in FIG. 6, as in the first embodiment.

When the tool button 333 is depressed on the screen shown in FIG. 3, a bookmark list display screen is displayed, as shown in FIG. 9, by performing the steps in the flowchart in FIG. 7, as in the first embodiment. The bookmark list display screen includes information input by the users or programs.

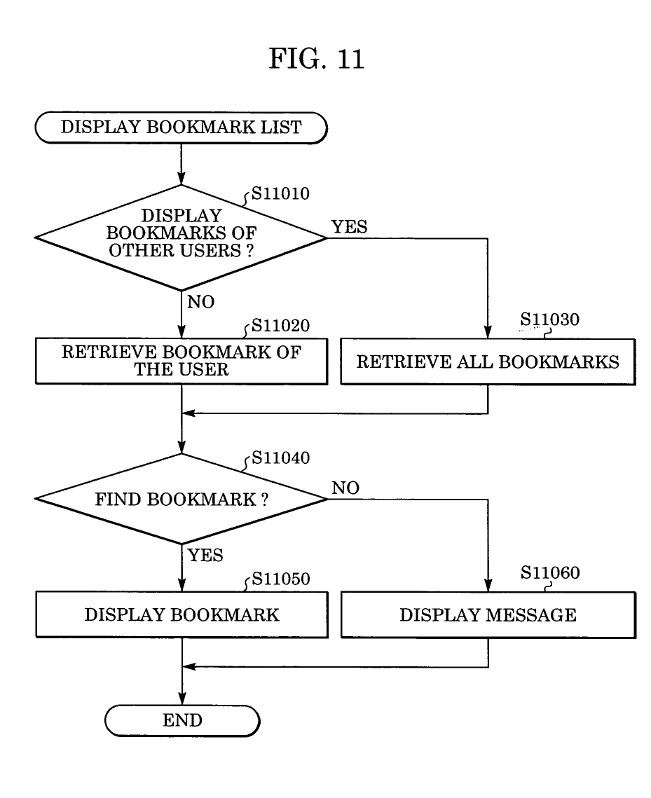

In FIG. 11, Step S7010 for displaying an initial screen in FIG. 9 is performed by the following steps.

Step S11010: Whether only the bookmarks of the present user or the bookmarks of other users in addition to the bookmarks of the present user are to be displayed is determined by accessing the input information. When only the bookmarks of the requesting user are to be displayed, the process proceeds to Step S11020. When the bookmarks of other users in addition to the bookmarks of the present user are to be displayed, the process proceeds to S11030.

Step S11020: The bookmarks of the user are extracted from the bookmark table 1200 in the DB 6 shown in FIG. 12, and the process proceeds to Step S11040.

Step S11030: The bookmarks of all the users are extracted from the bookmark table 1200 in the DB 6 shown in FIG. 2, and the process proceeds to Step S11040.

Step S11040: Whether or not bookmarks are extracted in Step S11020 or Step S11030 is determined. When the bookmarks are extracted, the process proceeds to Step S11050. When the bookmarks are not extracted, the process proceeds to Step S11060.

Step S11050: When the bookmarks are found in Step S11020 or Step S11030, a bookmark list is displayed in the list box 900. Then, the process is terminated.

Step S11060: A message indicating that the bookmarks are not extracted is displayed on the screen of the web client, and the bookmark list display screen is not displayed. Then, the process is terminated.

The DB 6 of the second embodiment includes the bookmark table 1200, shown in FIG. 12, in order to control the bookmarks for individual users, in addition to the document table 810, the page table 820, and the user table 840, as in the first embodiment.

Referring to FIG. 12, the bookmark table 1200 has a user ID 1204 of each user who created the bookmark, in addition to fields regarding the bookmark, such as a bookmark ID 1201, a document ID 1202, a Page ID 1203, and a comment 1206.

Records are created, deleted, accessed, and revised in the bookmark table 1200 as in the first embodiment.

According to the second embodiment, since a bookmark can be created and controlled for each user, a number of users can bookmark a common document data. Furthermore, only the bookmarks that the user created can be displayed or the bookmarks that other users created can also be displayed. Additionally, the bookmarks of the user cannot be deleted by other users.

### Third Embodiment

A document control system of a third embodiment according to the present invention will now be described by referring to the drawings.

The document management system of the third embodiment has the same structure as that of the first embodiment, shown in FIGS. 1 and 2. Also, operations to create and delete bookmarks, to display a bookmark list, and the like can be performed by, for example, the document browsing program shown in FIG. 3.

In the third embodiment, a separate bookmark can be set for each user, and whether or not bookmarks are made public can be set.

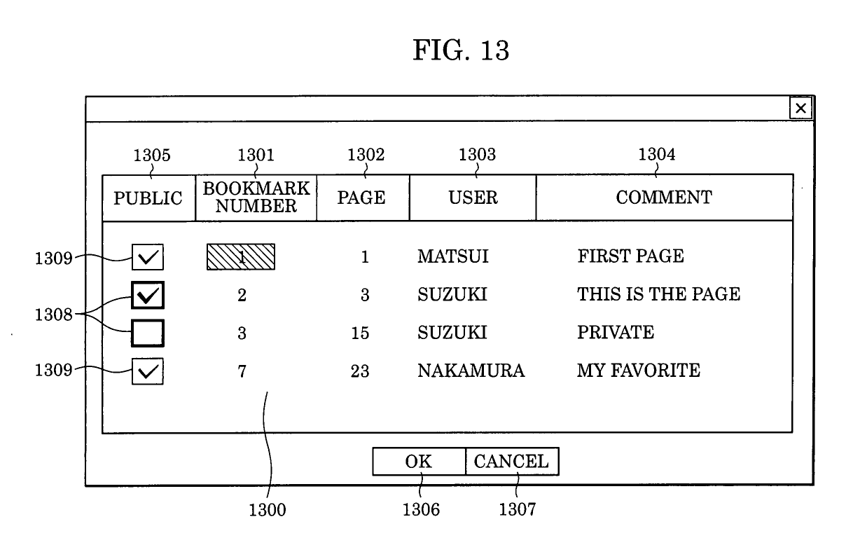

When the tool button 333 is depressed on the screen shown in FIG. 3, a bookmark list display screen such as the one shown in FIG. 13 is displayed. In the exemplary display screen shown in FIG. 13, the bookmark list display screen has a list box 1300 in the center and an OK button 1306 and a cancel button 1307 in the bottom. The list box 1300 includes a column for a public button 1305 for indicating whether or not the bookmark is made public, in addition to columns for a bookmark number 1301 and a page number 1302 of the page on which a bookmark is created, a user name 1303 of the user created the bookmark, and a comment 1304.

FIG. 13 shows a bookmark list display screen when the user is “Suzuki”. The bookmark list display screen displays not only the bookmarks this user created but also the bookmarks other users created. The column of the public button 1305 includes public checkboxes 1308. When the bookmarks are made public, checkmarks 1309 are checked in the public checkboxes 1308. Only the public checkboxes 1308 of the present user can be changed on this screen. The checkmarks 1309 assigned to the bookmarks of other users are shown in gray and cannot be changed on this screen. Therefore, whether or not checkmarks can be changed is visually clear by the color of the checkmark 1309.

The public checkboxes 1308 employ a toggle display. When the bookmark is made public, the checkmark 1309 is checked. When the bookmark is not made public, the checkmark 1309 is not checked.

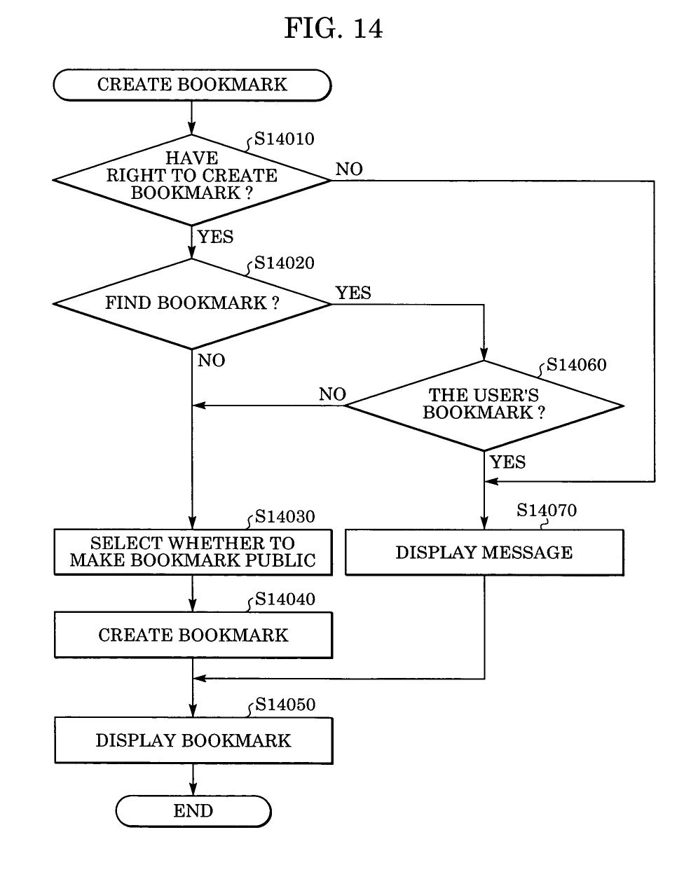

When the tool button 331 is depressed on the screen shown in FIG. 3, a bookmark is created by performing the steps shown in FIG. 14 and described next.

Step S14010: When a web client 3 or 4 requests to create a bookmark on a selected page, the web server 1 makes a query to the DB 6 so as to access a user table 840 with a user ID and confirms whether or not the requesting web client 3 or 4 has an access right. When the web server 1 confirms that the web client 3 or 4 has the access right, the process proceeds to Step S14020. When the web server 1 does not confirm that the requesting web client 3 or 4 has the access right, the process proceeds to Step S14070. In Step S14070, a message indicating that a bookmark cannot be created is displayed and the process is terminated.

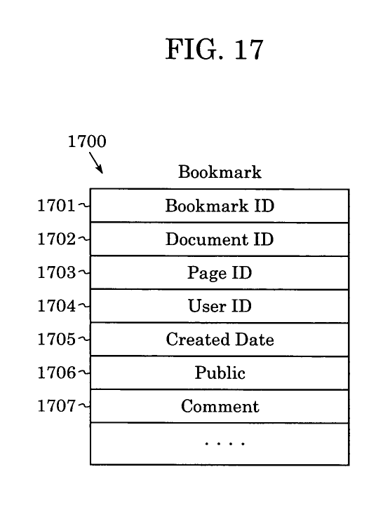

Step S14020: Whether or not the page on which a bookmark is to be created has at least one bookmark is checked using a document table 810, shown in FIGS. 8A-8C, and a bookmark table 1700, shown in FIG. 17, in the DB 6. When the page has not been bookmarked, the process proceeds to Step S14030. When the page has been bookmarked, the process proceeds to Step S14060.

Step S14030: A dialogue box asking the user whether or not the bookmark to be created will be made public is displayed in the web client of the user and the screen is on standby until the user inputs his/her choice. After the user inputs whether or not the bookmark is to be made public, the process proceeds to Step S14040.

Step S14040: A request to create a new bookmark is made of the web server 1. In accordance with the request, the web server 1 creates a new bookmark in the bookmark table 1700 and totals the number of bookmarks in the document table 810.

Step S14050: The created bookmark is displayed on the screen of the document browsing program and the process is terminated.

Step S14060: Whether or not the page on which a bookmark is to be created already has a bookmark of the user is checked. When the bookmark of the user is found, the process proceeds to Step S14070 to display an error message that the page has already been bookmarked by the user. When the bookmark of the user is not found, the process proceeds to Step S14030.

Step S14070: As described above, a message indicating that the user does not have a right to create a bookmark, or that the page has already been bookmarked by the user is displayed on the screen of the client, and the process is terminated.

When the tool button 332 is depressed on the screen shown in FIG. 3, a bookmark is deleted by performing the steps shown in the flowchart in FIG. 6, as in the first embodiment.

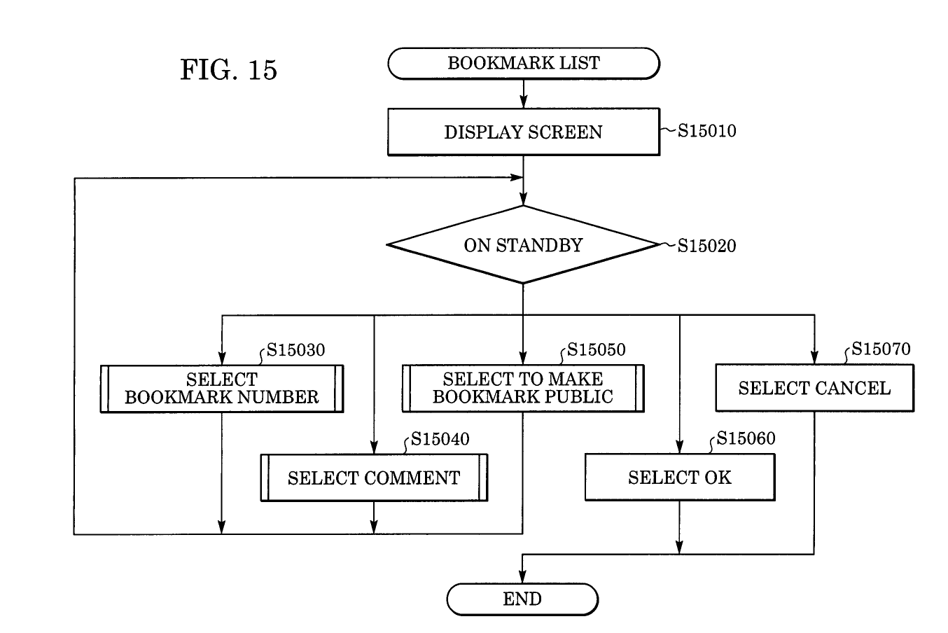

When the tool button 333 is depressed on the screen shown in FIG. 3, a bookmark list display screen is displayed, as shown in FIG. 13, by performing the steps in the flowchart in FIG. 15 described next.

Step S15010: An initial screen such as the one shown in FIG. 13 is displayed. By referring to the page table 820 and the bookmark table 1700, the initial display screen displays the bookmark number 1301, the page number 1302, the user name 1303, the comment 1304, and the public button 1305 in a list.

Step S15020: The process is on standby until a request is input. In accordance with the input request, the process proceeds to different steps. Specifically, when the bookmark number 1301 is selected, the process proceeds to Step S15030. When the comment 1304 is selected, the process proceeds to Step S15040. When the public button 1305 is selected, the process proceeds to Step S15050. When an OK button 1306 is selected, the process proceeds to Step S15060. When the cancel button 1307 is selected, the process proceeds to Step S15070.

Step S15030: The selected bookmark number is highlighted, and the process returns to Step S15020.

Step S15040: A comment is selected and the selected comment is made editable. When the comment is revised, a request to revise the comment is sent to the web server 1, and the web server 1 revises the comment in the bookmark table 1700. Then, the process returns to Step S15020.

Step S15050: Operation of the public checkboxes 1308 toggles on/off the checkmark 1309 in the public checkboxes 1308 to select whether or not the bookmark is to be shared, and a request to share or unshare the bookmark is sent to the web server 1. The web server 1 changes the information regarding bookmark-sharing (public information) in the bookmark table 1700. Then, the process returns to Step S15020.

Step S15060: The page on which the bookmark is created and which is selected on the bookmark list display screen is displayed on the screen of the document browsing program, and the process is terminated.

Step S15070: No process is performed on the bookmark list display screen and the process is terminated.

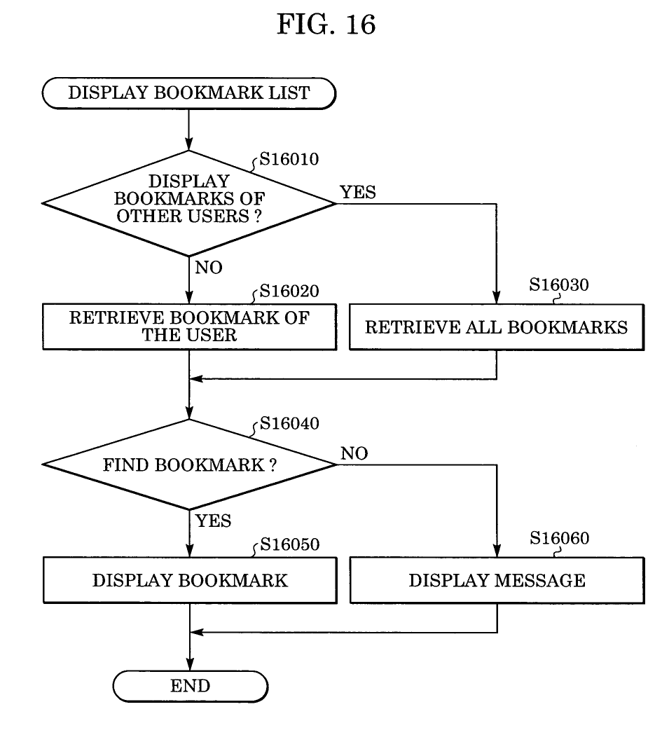

Step S15010 for displaying an initial screen in FIG. 15 is performed by the following steps shown in FIG. 16 and described next.

Step S16010: Whether only the bookmarks of the present user or the bookmarks of other users in addition to the bookmarks of the present user are to be displayed is determined with reference to the input information. When only the bookmarks of the present user are to be displayed, the process proceeds to Step S16020. When the bookmarks of other users in addition to the bookmarks of the present user are to be displayed, the process proceeds to Step S16030.

Step S16020: The bookmarks of the present user are extracted from the bookmark table 1700 (FIG. 17) in the DB 6, and the process proceeds to Step S16040.

Step S16030: The bookmarks of all the users are extracted from the bookmark table 1700 (FIG. 17) in the DB 6, and the process proceeds to Step S16040.

Step S16040: Whether or not the bookmarks are extracted in Step S16020 or Step S16030 is determined. When the bookmarks are extracted, the process proceeds to Step S16050. When the bookmarks are not extracted, the process proceeds to Step S16060.

Step S16050: When the bookmarks are extracted in Step S16020 or Step S16030, a bookmark list is displayed in the list box 1300.

Step S16060: A message indicating that no bookmarks have been created is displayed on the screen in the web client of the user. The bookmark list display screen is not displayed, and the process is terminated.

Since whether or not bookmarks are made public can be set in the document management system of the third embodiment, browsing of document data is controlled and leakage of the information on important pages is prevented. The third embodiment also achieves the effects of the second embodiment.

### Fourth Embodiment

A document management system of a fourth embodiment according to the present invention will now be described by referring to the drawings.

According to the document management systems of the first to third embodiments, the database used in the web application is controlled by a computer separate from the web server 1, that is, the DB server 2. By contrast, according to the fourth embodiment, a database program is directly controlled by the web server 1 in the document management system.

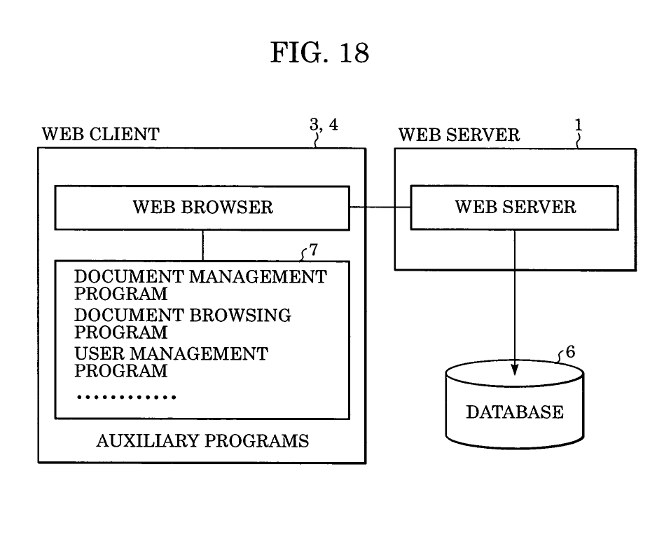

Referring to FIG. 18, the DB 6 is stored in the web server 1, and the database program is executed by the web server 1. This reduces access time.

### Fifth Embodiment

A document management system of a fifth embodiment according to the present invention will now be described.

According to the document management system of the first embodiment, session information of the web clients 3 and 4 is stored as a file in the web server 1 and controlled therein. By contrast, according to the fifth embodiment, session information is stored and controlled in the database in the DB server 2.

In the document management system of the fifth embodiment, loads on the web server 1 are reduced as compared to that of the first embodiment.

In the document management system of the above-described embodiments, CGI executes the web application program in the web server. Alternatively, the web application program may be executed with other means that can execute the web application program, such as server-side script or Java servlet.

The present invention is not limited to the database operation via a network as described above but may be applied to a bookmark function for a database in a single computer.

### Other Embodiments

The document management system of the above-described embodiments may be performed by providing the system with a storage medium storing program code for software to allow the system to operate, where the computer, that is, a central processing unit (CPU) or a micro-processing unit (MPU), in the system reads the program code stored in the storage medium.

In this case, the program code read out from the storage medium realizes the functions of the aforementioned embodiments.

Examples of the storage medium for supplying the program code include a floppy disk, hard disk, optical disk, magneto-optical disk, compact disk read-only memory (CD-ROM), compact disk recordable (CD-R), magnetic tape, nonvolatile memory card, and read-only memory (ROM).

As described above, the functions of the above-described embodiments are achieved by executing the program code read out by the computer. Alternatively, an operating system (OS) for the computer may perform part or all of the process of the above embodiments in response to commands of the program code, and thus, the functions of the above-described embodiments may be accomplished.

Alternatively, after the program code is written in memory in an extension board inserted into the computer or an extension unit connected to the computer, a CPU in the board or unit may perform a part or all of the process in response to the program code, and thus, the functions of the above-described embodiments may be accomplished.

When the present invention is applied to the aforementioned storage medium, the program code for performing the steps in the above-described flowcharts shown in the drawings is stored in the storage medium. The computer program of the present invention may be read and executed in an external device via a network.

While the present invention has been described with reference to exemplary embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2004-088237 filed on Mar. 25, 2004, which is hereby incorporated by reference herein.

1. A document management system comprising:
a server for controlling document data using a database in which the document data are stored; and
a client connected to the server via a network, the server comprising:
a bookmark-creating unit for creating a bookmark at a desired position in the document data in response to a request to create the bookmark from the client;
a storing unit for storing bookmark information in a bookmark database; and
a transmitting unit for transmitting the bookmark information to the client,
the client comprising:
a bookmark-creation-requesting unit for requesting the server to create the bookmark at a desired position in the document data in response to a request from the client; and
a display unit for displaying the bookmark information transmitted from the server, the bookmark information being associated with the document data on the display.

2. The document management system according to claim 1, wherein the server is a web server, and the client is a web client.

3. The document management system according to claim 1, wherein the bookmark is created on a desired page of the document data.

4. The document management system according to claim 1, wherein the server includes a web server and a database server.

5. The document management system according to claim 1, wherein the server further comprises an access-right-controlling unit for controlling an access right of a user to the bookmark information.

6. The document management system according to claim 5, wherein the access right is a right to create the bookmark in the document data.

7. The document management system according to claim 5, wherein the access right is a right to delete the bookmark in the document data.

8. The document management system according to claim 1, wherein the bookmark information is associated with a user who created the bookmark and is stored in the bookmark database, the document management system further comprising a determining unit for determining whether to display a bookmark created by another user.

9. The document management system according to claim 1, further comprising a public-determining unit for determining whether to share the bookmark information with another user in accordance with a request from the client.

10. The document management system according to claim 9, wherein when a user of the client requests the display unit in the client to display a list of bookmarks created in the document data, the display unit displays a bookmark list including a bookmark created by the user requested to display the bookmark list and a public bookmark created by another user.

11. The document management system according to claim 9, wherein the public-determining unit allows only the bookmark of the user of the client to be determined whether to be made public.

12. The document management system according to claim 1, wherein the bookmark information includes an identification of a page on which the bookmark is created, an identification of a document data including the page, and a comment for the bookmark.

13. A document management server for controlling document data using a database in which the document data are stored by communicating with a client via a network, the server comprising:
a bookmark-creating unit for creating a bookmark at a desired position in the document data in response to a request to create a bookmark from the client;
a storing unit for storing bookmark information in a bookmark database; and
a transmitting unit for transmitting the bookmark information to the client,
wherein the client displays the bookmark information transmitted from the server, the bookmark information being associated with the document data on the display.

14. The document management server according to claim 13, further comprising an access-right-controlling unit for controlling an access right of a user to the bookmark information.

15. The document management server according to claim 13, wherein the bookmark information is associated with a user who created the bookmark and is stored in the bookmark database, the document management server further comprising a determining unit for determining whether to display a bookmark created by another user.

16. The document management server according to claim 13, further comprising a public-determining unit for determining whether to share the bookmark information with another user in accordance with a request from the client.

17. A document management client connected to a server for controlling document data via a network, the client comprising:
a bookmark-creation-requesting unit for requesting the server to create a bookmark at a desired position in the document data in response to a request from a user; and
a display unit for displaying bookmark information transmitted from the server, the bookmark information being associated with the document data on the display,
wherein the server comprises:
a bookmark-creating unit for creating the bookmark at the desired position in the document data in response to a request from the client to create the bookmark;
a storing unit for storing the bookmark information in a bookmark database; and
a transmitting unit for transmitting the bookmark information to the client.

18. A document management method for controlling a system including a server for controlling document data using a database in which the document data are stored and a client connected to the server via a network, wherein the server performs steps comprising:
creating a bookmark at a desired position in the document data in response to a request from the client to create the bookmark;
storing bookmark information in a bookmark database; and
transmitting the bookmark information to the client,
wherein the client performs steps comprising:
requesting the server to create the bookmark at the desired position in the document data in response to a request from a user of the client; and
displaying the bookmark information transmitted from the server, the bookmark information being associated with the document data on the display.

19. A document management method for controlling a server for controlling document data using a database in which the document data are stored by communicating with a client via a network, the method comprising:
creating a bookmark at a desired position in the document data in response to a request from the client to create the bookmark;
storing bookmark information in a bookmark database; and
transmitting the bookmark information to the client,
wherein the client displays the bookmark information transmitted from the server, the bookmark information being associated with the document data on the display.

20. A computer program for controlling a system including a server for controlling document data using a database in which the document data are stored and a client connected to the server via a network, the program comprising program code for allowing the server to perform steps comprising:
a bookmark-creating step for creating a bookmark at a desired position in the document data in response to a request from the client to create the bookmark;
a storing step for storing bookmark information in a bookmark database; and
a transmitting step for transmitting the bookmark information to the client,
and program code for allowing the client to perform steps comprising:
a bookmark-creation-requesting step for requesting the server to create the bookmark at the desired position in the document data in response to a request from a user of the client; and
a display step for displaying the bookmark information transmitted from the server, the bookmark information being associated with the document data on the display.

21. A computer program for controlling a server for controlling document data using a database in which the document data are stored by communicating with a client via a network, the program comprising program code for allowing a computer to perform steps comprising:
a bookmark-creating step for creating a bookmark at a desired position in the document data in response to a request from the client to create the bookmark;
a storing step for storing bookmark information in a bookmark database; and
a transmitting step for transmitting the bookmark information to the client,
wherein the client displays the bookmark information transmitted from the server, the bookmark information being associated with the document data on the display.
